(19) United States
(12) Patent Application Publication
(10) Pub. No.: US 2024/0175569 A1
(43) Pub. Date: May 30, 2024

(54) DUAL AXIS SWIVEL YOKE DESIGN FOR FLOOD LIGHT

(71) Applicant: Eaton Intelligent Power Limited, Dublin (IE)

(72) Inventors: Christopher G. Henley, Pittsburgh, PA (US); Anzar Pandurang Rade, Pune (IN); Adarsh Mishra, Pune (IN)

(21) Appl. No.: 18/522,546

(22) Filed: Nov. 29, 2023

Related U.S. Application Data
(60) Provisional application No. 63/385,505, filed on Nov. 30, 2022.

(51) Int. Cl. F21V 21/30; F21V 29/70

(52) U.S. Cl. CPC F21V 21/30; F21V 29/70

(57) ABSTRACT

A light assembly including a heat sink assembly including an extrusion. The extrusion defines at least one internal passageway between a lower face and an upper face. The at least one internal passageway has an open upper end and an open lower end wherein air is drawn into the open lower end and exhausted out the open upper end via natural convection. A swivel yoke assembly is attached to the lower face of the heat sink assembly. The swivel yoke assembly includes an upper bracket, a lower bracket and a swivel hub attached to upper bracket and the heat sink assembly. The upper bracket and the lower bracket are configured to pivot about a horizontal axis relative to each other and the swivel hub is rotatable about a vertical axis.

### PRIORITY

This application claims the benefit of priority of provisional U.S. Patent Application No. 63/385,505, filed Nov. 30, 2022, the contents of which are incorporated herein by reference in their entirety.

### FIELD

The subject application relates to light assemblies. More particularly, a mechanism for allowing an orientation of a light assembly to be adjusted by a user.

### BACKGROUND

Flood light assemblies find particular application in illuminating large areas. Some light assemblies require a complex arrangement of nuts and bolts to fix the light assembly to desired orientation to illuminate a predetermined area.

There is a need for a mechanism for allowing the orientation of a light assembly to be quickly and easily adjusted by a user.

The present invention provides a swivel yoke assembly that allows a user the ability to quickly and easily adjust the orientation of a light assembly to illuminate a predetermined area.

### SUMMARY OF THE INVENTION

There is provided a light assembly including a heat sink assembly including an extrusion. The extrusion defines at least one internal passageway between a lower face and an upper face. The at least one internal passageway has an open upper end and an open lower end wherein air is drawn into the open lower end and exhausted out the open upper end via natural convection. A swivel yoke assembly is attached to the lower face of the heat sink assembly. The swivel yoke assembly includes an upper bracket, a lower bracket and a swivel hub attached to upper bracket and the heat sink assembly. The upper bracket and the lower bracket are configured to pivot about a horizontal axis relative to each other and the swivel hub is rotatable about a vertical axis.

In the foregoing light assembly, the swivel hub is rotatable between about +/−45 degrees and about +/−90 degrees about the vertical axis.

In the foregoing light assembly, the upper bracket and the lower bracket are pivotable between about +/−30 degrees and about +/−90 degrees about the horizontal axis.

In the foregoing light assembly, a plurality of fins are provided within the at least one internal passageway.

In the foregoing light assembly, the plurality of fins are integral with the extrusion.

In the foregoing light assembly, a fastener is provided for fixing a position of the upper bracket and the lower bracket about the horizontal axis.

In the foregoing light assembly, a fastener is provided for fixing a position of the swivel hub about the vertical axis.

There is further provided a swivel yoke assembly attachable to a light assembly for allowing the light assembly to pivot about a horizontal axis and rotate about a vertical axis. The swivel yoke assembly includes an upper bracket, a lower bracket, and a swivel hub attachable to the upper bracket and configured to attach to the light assembly. The upper bracket and the lower bracket are configured to pivot about a horizontal axis relative to each other and the swivel hub is rotatable about a vertical axis.

In the foregoing swivel yoke assembly, the swivel hub is rotatable between about +/−45 degrees and about +/−90 degrees about the vertical axis.

In the foregoing swivel yoke assembly, the upper bracket and the lower bracket are pivotable between about +/−30 degrees and about +/−90 degrees about the horizontal axis.

In the foregoing swivel yoke assembly, a fastener is provided for fixing a position of the upper bracket and the lower bracket about the horizontal axis.

In the foregoing swivel yoke assembly, a fastener is provided for fixing a position of the swivel hub about the vertical axis.

There is further provided a light assembly that includes a heat sink assembly including an extrusion. The extrusion defines at least one internal passageway between a lower face and an upper face. The at least one internal passageway has an open upper end and an open lower end wherein air is drawn into the open lower end and exhausted out the open upper end via natural convection A swivel yoke assembly is attached to the lower face of the heat sink assembly. The swivel yoke assembly includes an upper bracket, a lower bracket and a swivel hub attached to upper bracket and the heat sink assembly wherein the upper bracket and the lower bracket are configured to pivot between about +/−30 degrees and about +/−90 degrees about a horizontal axis and the swivel hub is configured to rotate between about +/−45 degrees and about +/−90 degrees about a vertical axis. A first fastener is provided for fixing a position of the upper bracket and the lower bracket about the horizontal axis. A second fastener is provided for fixing a position of the swivel hub about the vertical axis.

### BRIEF DESCRIPTION OF THE DRAWINGS

FIG. 1 is front perspective view of a light assembly;

FIG. 2 is a rear perspective view of the light assembly of FIG. 1;

FIG. 3 is an exploded view of the light assembly of FIG. 1;

FIG. 4A is a perspective view of an extrusion of the light assembly of FIG. 1;

FIG. 4B is a sectioned view of the extrusion of FIG. 4A, taken along line 4B-4B of FIG. 4A;

FIG. 5 is a top view of the extrusion of FIG. 4A;

FIG. 6 is a perspective view of a swivel hub of the light assembly of FIG. 1;

FIG. 7 is a front exploded view of a swivel yoke assembly of the light assembly of FIG. 1;

FIG. 8 is an enlarged view of a lower portion of the light assembly of FIG. 1;

FIG. 9 is a sectioned view of the light assembly of FIG. 1, taken along line 9-9 of FIG. 1;

FIG. 10A is a perspective view of the light assembly of FIG. 1 in a first rotated position about a horizontal pivot axis;

FIG. 10B is a perspective view of the light assembly of FIG. 1 in a second rotated position about a horizontal pivot axis;

FIG. 11A is a perspective view of the light assembly of FIG. 1 in a first rotated position about a vertical pivot axis;

FIG. 11B is a perspective view of the light assembly of FIG. 1 in a second rotated position about a vertical pivot axis; and

FIG. 12 is a sectioned view of the light assembly of FIG. 1, taken along line 12-12 of FIG. 1.

### DETAILED DESCRIPTION

The following presents a description of the disclosure; however, aspects may be embodied in many different forms and should not be construed as limited to the embodiments set forth herein. Furthermore, the following examples may be provided alone or in combination with one or any combination of the examples discussed herein.

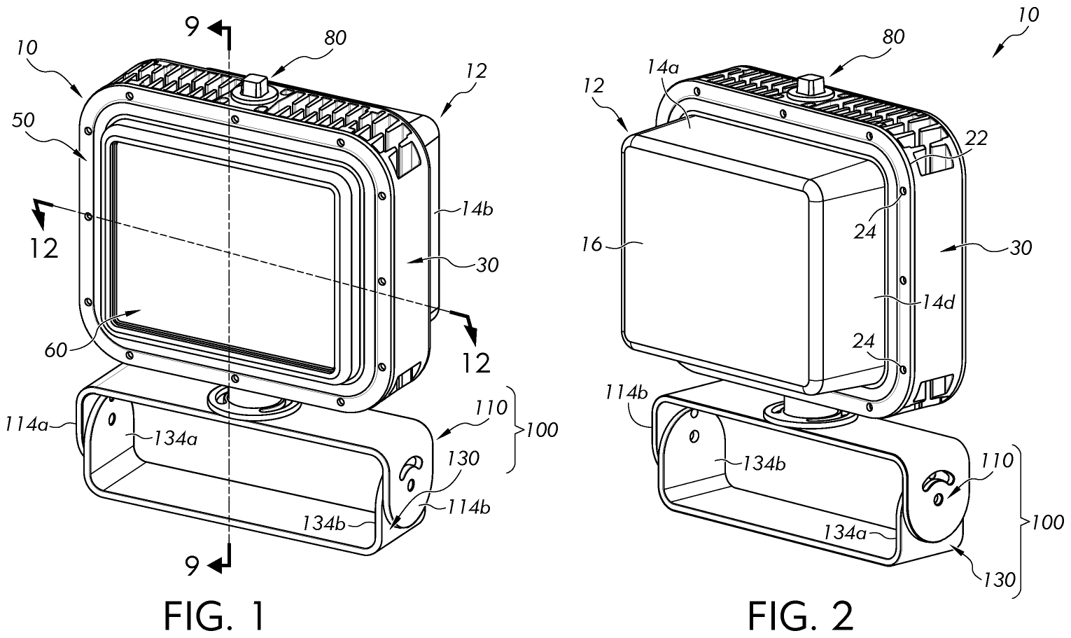

As shown in FIGS. 1-3, a light assembly 10 generally includes an upper assembly (also referred to as a heat sink assembly) and a swivel yoke assembly 100. The upper assembly includes a housing 12, an extrusion 30 and a bezel 50. The housing 12 includes side walls 14a, 14b, 14c 14d and an end wall 16 that together define an interior cavity 18 of the housing 12. A flange 22 extends outwardly from a periphery of the side walls 14a, 14b, 14c, 14d for defining a mating surface of the housing 12. A plurality of spaced-apart holes 24 extend through the flange 22 for receiving fasteners (not shown) for securing the housing 12 to the extrusion 30. The interior cavity 18 of the housing 12 is dimensioned to receive a driver subassembly (not shown).

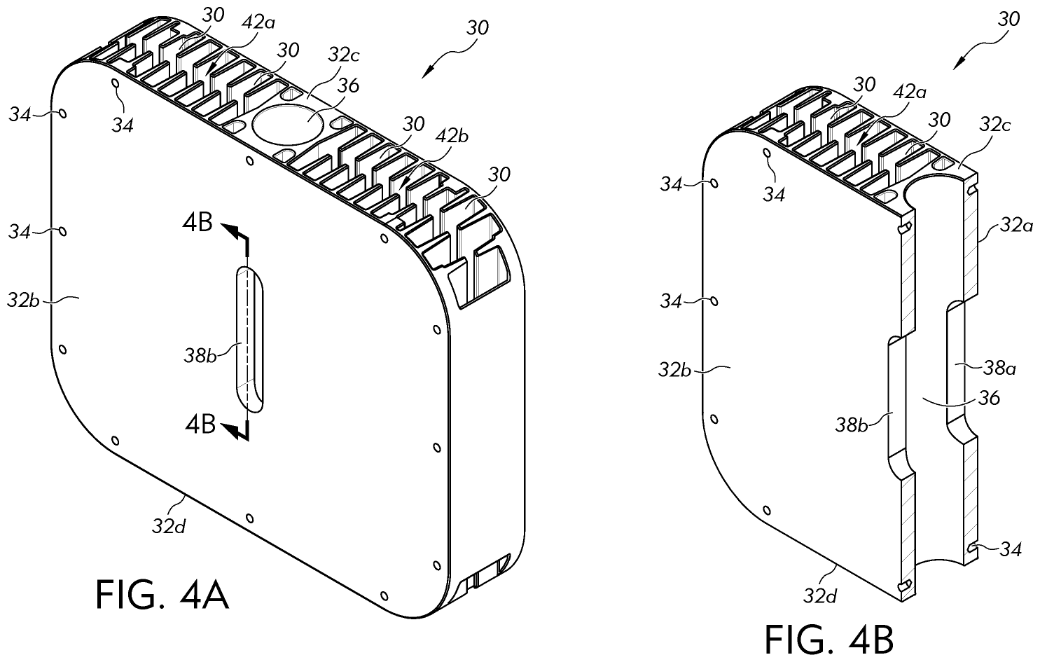

The flange 22 includes a groove that this dimensioned to receive a housing seal element 28. The housing seal element 28 is configured to be compressed between the flange 22 and a first face 32a(FIG. 4B) of the extrusion 30 to allow the housing 12 and the extrusion 30 to be sealingly secured to each other.

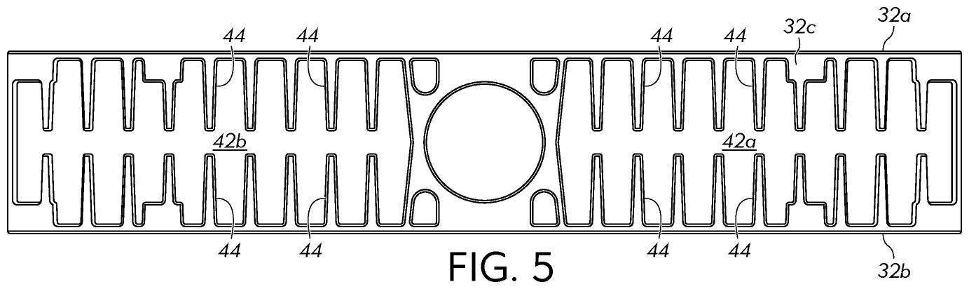

The extrusion 30 is positioned adjacent the housing 12. The extrusion 30 includes the first face 32a that engages the flange 22 of the housing 12. Referring to FIGS. 4A-5, a plurality of spaced-apart mounting holes 34 extend into the first face 32a and a second face 32b of the extrusion 30. The mounting holes 34 on the first face 32a are positioned and dimensioned to align with the holes 24 in the flange 22 of the housing 12 such that fasteners (not shown) may extend through the holes 24 and thread into the mounting holes 34 for securing the housing 12 to the first face 32a. The mounting holes 34 on the second face 32b are positioned and dimensioned as described in detail below.

A through passage 36 extends between a lower face 32c and an upper face 32d of the extrusion 30. In the embodiment illustrated, the through passage 36 is a cylindrical-shaped hole. A first elongated slot 38a extends through the first face 32a to the passage 36 and a second elongated slot 38b extends through the second face 32b to the passage 36. In the embodiment illustrated, the first and second elongated slots 38a, 38b are oblong and extend parallel to a longitudinal axis of the passage 36. A threaded plug 80 (FIGS. 1-3) may be provided for sealing an upper opening of the passage 36 in the extrusion 30.

A first passageway 42a and a second passageway 42b extend through the extrusion 30 between the lower face 32c and the upper face 32d. A plurality of spaced-apart fins 44 extend into the first passageway 42a and the second passageway 42b. The fins 44 define cooling fins that are configured to aid in cooling the extrusion 30 during operation, as described in detail below. In the embodiment illustrated, the plurality of spaced-apart fins are integral with the body of the extrusion 30. It is contemplated that plurality of spaced-apart fins may be separately manufactured from the body of the extrusion 30 and later attached thereto.

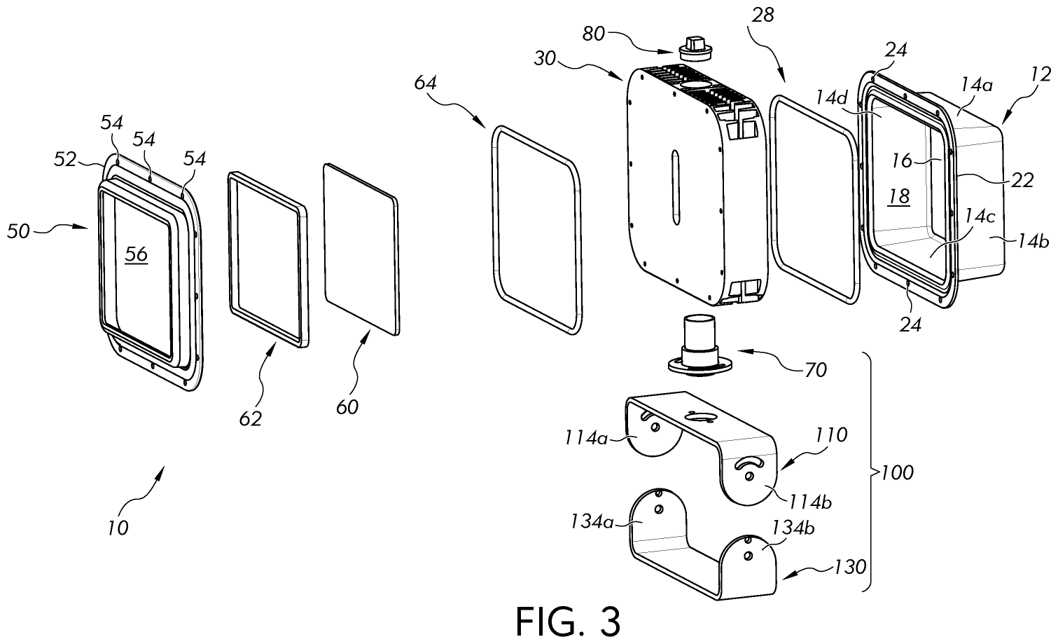

Referring to FIG. 3, the bezel 50 is attached to the second face 32b of the extrusion 30. The bezel 50 is a ring-shaped element having a flange 52 extending outwardly from a perimeter of the bezel 50. The bezel 50 has a central opening 56. A plurality of spaced-apart holes 54 extend through the flange 52. The holes 54 are positioned and dimensioned to align with the mounting holes 34 on the second face 32b of the extrusion 30. The holes 54 are dimensioned to receive fasteners (not shown) for securing the bezel 50 to the extrusion 30. The bezel 50 defines a central opening 56.

A cover 60 is attached to the bezel 50 proximate the central opening 56. A cover seal element 62, e.g., a gasket, is provided for sealingly attaching the cover 60 to the bezel 50. The cover 60 is configured to be translucent to light such that light from lighting components (not shown) positioned on the second face 32b of the extrusion 30 may pass through the cover 60.

A bezel seal element 64 is positioned between the flange 52 of the bezel 50 and the second face 32b of the extrusion 30. The bezel seal element 64 is configured to be compressed between the flange 52 and the second face 32b of the extrusion 30 to allow the bezel 50 and the extrusion 30 to be sealingly secured to each other.

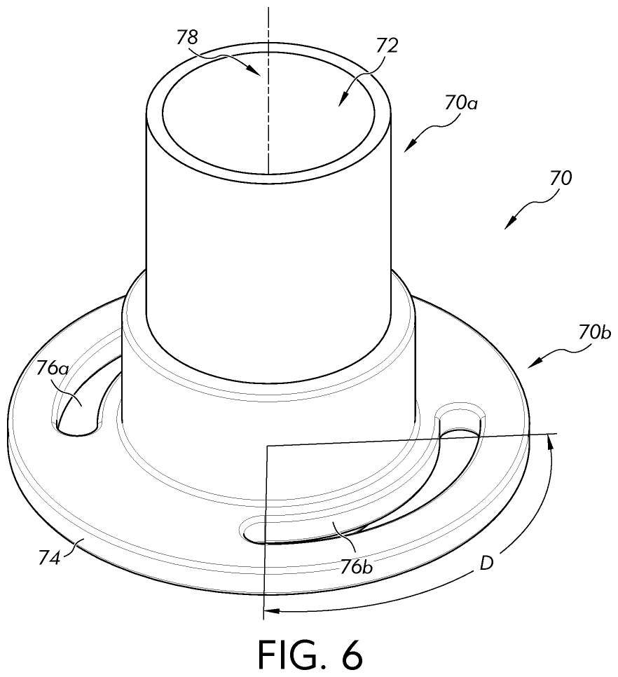

Referring to FIG. 3, the swivel yoke assembly 100 is attached via a swivel hub 70 to a lower portion of the extrusion 30. Referring to FIG. 6, the swivel hub 70 is a generally cylindrical-shaped element having an upper end 70a and a lower end 70b. The upper end 70a is dimensioned to extend into and be secured to the passage 36 of the extrusion 30. An opening 72 extends through the swivel hub 70 between the upper end 70a and the lower end 70b. A flange 74 extends outwardly from a periphery near the lower end 70b. A pair of arcuate slots 76a, 76b extend through the flange 74 about a longitudinal axis 78 of the swivel hub 70. The slots 76a, 76b extend the angle D degrees and are disposed diametrically opposite to each other. In the embodiment illustrated, D is about 90 degrees. It is contemplated that the angle D may be between about 45 degrees and about 90 degrees, preferably about 60 degrees.

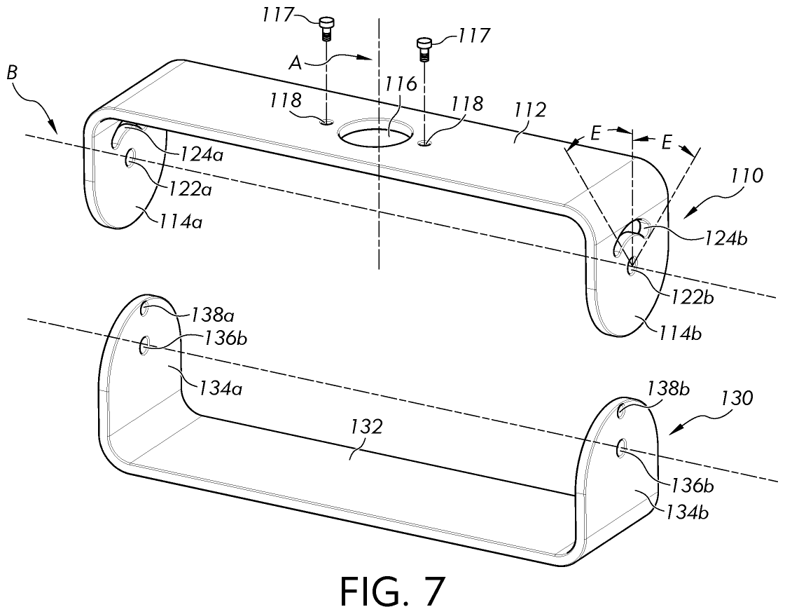

Referring to FIG. 7, the swivel yoke assembly 100 also includes an upper bracket 110 and a lower bracket 130. The upper bracket 110 is U-shaped with a base portion 112 and a first leg 114a and a second leg 114b extending in a generally perpendicular orientation from opposite ends of the base portion 112. A hole 116 extends through a mid-portion of the base portion 112 for receiving the lower end 70b of the swivel hub 70 (FIG. 6). The hole 116 defines a vertical pivot axis A of the swivel yoke assembly 100. Two holes 118 are positioned on opposite sides of the hole 118 for receiving a fastener 117.

The first leg 114a includes a hole 122a that axially aligns with a hole 122b in the second leg 114b. The holes 122a, 122b define a horizontal pivot axis B of the swivel yoke assembly 100. A first arcuate slot 124a and a second arcuate slot 124b are provided in the first and second legs 114a, 114b above the holes 122a, 122b, respectively, and both extend about the horizontal pivot axis B of the swivel yoke assembly. The slots 124a, 124b extend +/−E degrees from a vertical line. In the embodiment illustrated, the angle E is about 30 degrees. It is contemplated that the angle E may be between about 30 degrees and about 90 degrees, preferably about 90 degrees.

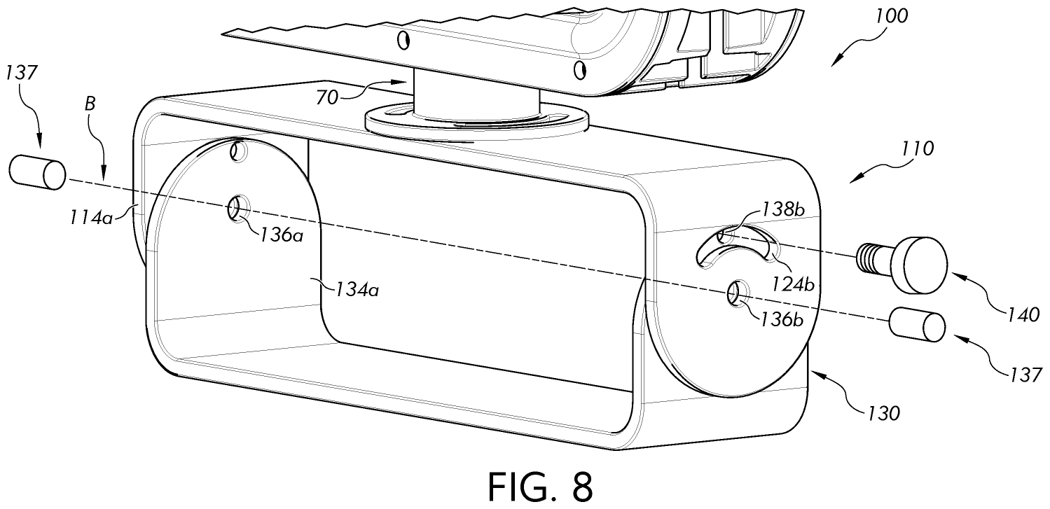

The lower bracket 130 is U-shaped with a base portion 132 and a first leg 134a and a second leg 134b extending in a generally perpendicular orientation from opposite ends of the base portion 132. The first leg 134a includes a hole 136a that axially aligns with a hole 136b in the second leg 134b. A first hole 138a and a second hole 138b are provided in the first and second legs 134a, 134b above the holes 136a, 136b, respectively. The first and second holes 138a, 138b each are dimensioned to receive a threaded fastener 140 (FIG. 8).

The light assembly 10 may be assembled as described herein below. Referring to FIGS. 1-3, the upper assembly is assembled by attaching the housing 12 to the first face 32a of the extrusion 30 via fasteners (not shown) that extend through holes 24 in the flange 22 of housing 12 into mounting holes 34 in the first face 32a of the extrusion 30. The housing seal element 28 is positioned between the flange 22 and the first face 32a to sealingly connect the housing 12 to the extrusion 30. When connected, the housing 12 and the extrusion 30 define a cavity for receiving electrical components (not shown).

The bezel 50 is secured to the second face 32b of the extrusion 30 via fasteners (not shown) that extend through holes 54 in the bezel 50 and thread into mounting holes 34 in the second face 32b. The bezel seal element 64 is positioned between the flange 52 of the bezel 50 and the second face 32b to sealingly connect the bezel 50 to the extrusion 30. The cover 60 is secured to the bezel 50 via the cover seal element 62 to allow the cover 60 to close the central opening 56 of the bezel 50. When secured to the extrusion 30, the bezel, the cover 60, the seal elements 62, 64 and the extrusion 30 define a sealed cavity that is configured to receive lighting components (not shown).

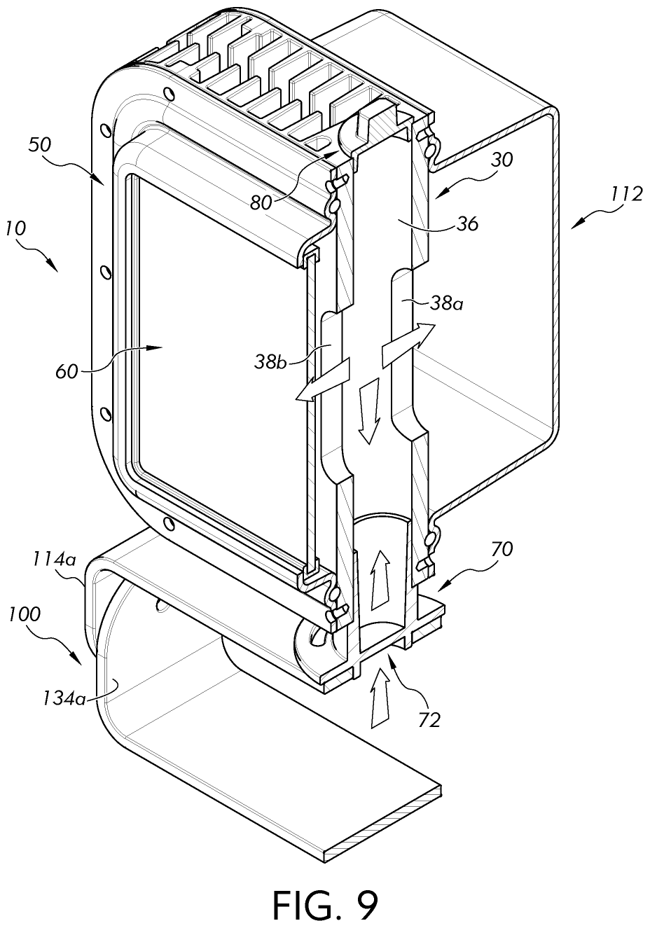

Referring to FIGS. 3, 4B, 6 and 9, the swivel hub 70 of the swivel yoke assembly 100 is attached to the extrusion 30 by inserting the upper end 70a of the swivel hub 70 into the passage 36 of the extrusion 30. The opening 72 in the swivel hub 70 communicates with the passage 36 to define a passageway the extends from the lower end 70b of the swivel hub 70, through the swivel hub 70, through the passage 36, through either of the first or second elongated slots 38a, 38b into the interior cavity 18 of the housing 12 or the space formed between the second face 32b of the extrusion 30 and the cover 60. In the embodiment illustrated in FIG. 9, a wall is formed in the passage 36 near the lower end 70b. It is contemplated that this wall may be removed during assembly to allow access into the passage 36.

The lower end 70b of the swivel hub 70 is inserted into the hole 116 (FIG. 7) in the upper bracket 110. The lower end 70b may be configured to be secured in the hole 116 in a manner that allows the swivel hub 70 to rotate within the hole 116. It is contemplated that various means may be used to retain the lower end 70b in the hole 116, for example, but not limited to, the lower end 70b may flared after being inserted into the hole 116, the lower end 70b may be threaded and a nut may be used to secure the swivel hub 70 in the hole 116 or other means, such as nuts, pins or tabs may be used to rotatably retain the swivel hub 70 in the hole 116.

The lower end 70b extends into the hole 116 in the upper bracket 110 until the flange 74 of the swivel hub 70 is positioned adjacent an upper surface of the base portion 112. The swivel hub 70 is positioned and dimensioned so that the arcuate slots 76a, 76b in the flange 74 align with holes 116 in the base portion 112. The fasteners 117 (FIG. 7) may extend through the arcuate slots 76a, 76b and thread into the holes 116. When the fasteners 117 are tightened, the orientation of the swivel hub 70 about the vertical pivot axis A can be fixed to a desired orientation, as described in detail below.

Referring to FIG. 8, the first and second legs 134a, 134b of the lower bracket 130 are positioned adjacent the first and second legs 114a, 114b of the upper bracket 110. The lower bracket 130 and the upper bracket 110 are connected via pivot pins 137 that extend through the axially aligned holes 122a, 122b of the upper bracket 110 and the axially aligned holes 136a, 136b of the lower bracket 130. Pivot pins 137 are dimensioned to secure the foregoing legs together while allowing the upper bracket 110 and the lower bracket 130 to pivot about the horizontal pivot axis B.

Threaded fasteners 140 may be used for securing the upper bracket 110 and the lower bracket 130 together in a fixed orientation relative to the horizontal pivot axis B. In FIG. 8, only one threaded fastener 140 is illustrated and described. The description of the fastener on the other leg is identical to the description of fastener 140 except it extends through the first hole 138a and slot 124a. The fastener 140 extends through the second arcuate slot 124b in the upper bracket 110 into the second hole 138b of the lower bracket 130. The threaded fastener 140 is configured so that, when tightened, the orientation of the upper bracket 110 relative to the lower bracket 130 about the horizontal pivot axis B is fixed.

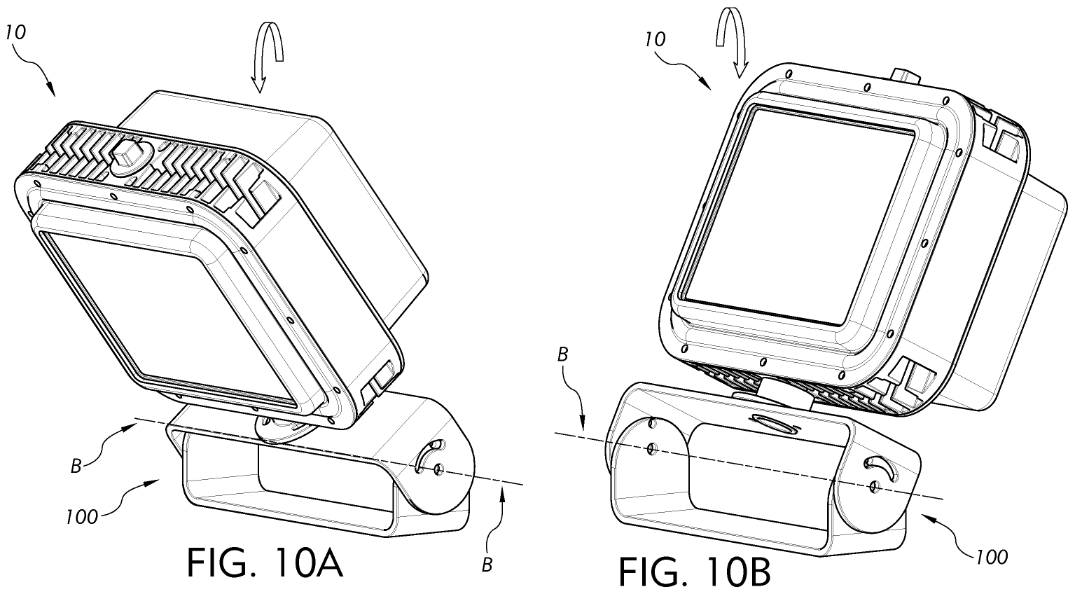

FIG. 10A illustrates the light assembly 10 in a first horizontal pivoted position about the horizontal pivot axis B and FIG. 10B illustrates the light assembly 10 in a second horizontal pivoted position about the horizontal pivot axis B. In the embodiment illustrated, the first horizontal pivoted position angles the light assembly 10 about 30 degrees forward and the second horizontal pivoted position angles the light assembly about 30 degrees backwards.

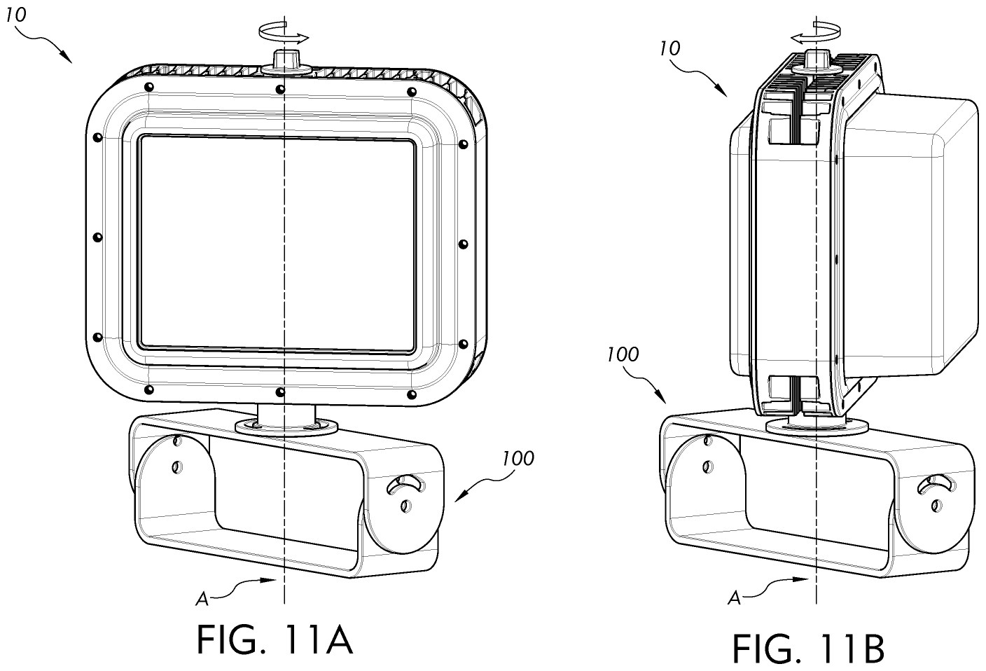

FIG. 11A illustrates the light assembly 10 in a first rotated position about the vertical pivot axis A and FIG. 11B illustrate the light assembly 10 in a second rotated position about the vertical pivot axis A. In the embodiment illustrated, the first rotated position is about 90 degrees from the second rotated position.

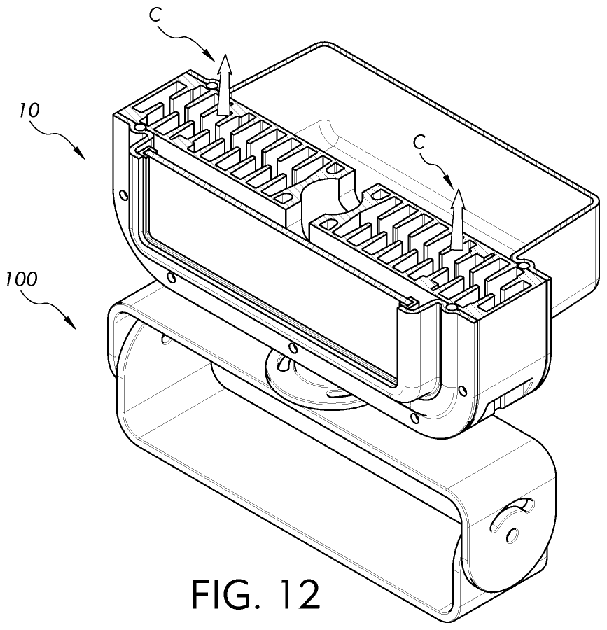

FIG. 12 illustrates heat flow paths C through the extrusion 30. It is contemplated that heat generated by the electrical components (not shown) in the housing 12 and those in the space between the extrusion 30 and the cover 60 may be conducted to the extrusion 30. The fins 44 of the extrusion 30 may be used to conduct the heat away from the light assembly 10 via natural convection.

It is contemplated that the range of pivot of the light assembly 10 about the horizontal pivot axis B may be limited based on a predetermined minimum heat transfer rate from the extrusion 30. As the angle of the light assembly 10 about the horizontal pivot axis B increases, the rate of heat transfer from the extrusion 30 via natural convection decreases. It is contemplated that the range of pivot of the light assembly 10 about the horizontal pivot axis may be +/−30 degrees.

It will be apparent to those skilled in the art that various modifications and variations can be made without departing from the spirit and scope of the claimed invention.

We claim:

1. A light assembly, comprising:
a heat sink assembly comprising an extrusion, the extrusion defining at least one internal passageway between a lower face and an upper face, the at least one internal passageway having an open upper end and an open lower end wherein air is drawn into the open lower end and exhausted out the open upper end via natural convection; and
a swivel yoke assembly attached to the lower face of the heat sink assembly; the swivel yoke assembly comprising:
an upper bracket,
a lower bracket, and
a swivel hub attached to upper bracket and the heat sink assembly,
wherein the upper bracket and the lower bracket are configured to pivot about a horizontal axis relative to each other and the swivel hub is rotatable about a vertical axis.

2. The light assembly of claim 1, wherein the swivel hub is rotatable between about +/−45 degrees and about +/−90 degrees about the vertical axis.

3. The light assembly of claim 1, wherein the upper bracket and the lower bracket are pivotable between about +/−30 degrees and about +/−90 degrees about the horizontal axis.

4. The light assembly of claim 1, wherein a plurality of fins are provided within the at least one internal passageway.

5. The light assembly of claim 4, wherein the plurality of fins are integral with the extrusion.

6. The light assembly of claim 1, wherein a fastener is provided for fixing a position of the upper bracket and the lower bracket about the horizontal axis.

7. The light assembly of claim 1, wherein a fastener is provided for fixing a position of the swivel hub about the vertical axis.

8. A swivel yoke assembly attachable to a light assembly for allowing the light assembly to pivot about a horizontal axis and rotate about a vertical axis, the swivel yoke assembly comprising:
an upper bracket;
a lower bracket; and
a swivel hub attachable to the upper bracket and configured to attach to the light assembly,
wherein the upper bracket and the lower bracket are configured to pivot about a horizontal axis relative to each other and the swivel hub is rotatable about a vertical axis.

9. The swivel yoke assembly of claim 8, wherein the swivel hub is rotatable between about +/−45 degrees and about +/−90 degrees about the vertical axis.

10. The swivel yoke assembly of claim 8, wherein the upper bracket and the lower bracket are pivotable between about +/−30 degrees and about +/−90 degrees about the horizontal axis.

11. The swivel yoke assembly of claim 8, wherein a fastener is provided for fixing a position of the upper bracket and the lower bracket about the horizontal axis.

12. The swivel yoke assembly of claim 8, wherein a fastener is provided for fixing a position of the swivel hub about the vertical axis.

13. A light assembly, comprising:
a heat sink assembly comprising an extrusion, the extrusion defining at least one internal passageway between a lower face and an upper face, the at least one internal passageway having an open upper end and an open lower end wherein air is drawn into the open lower end and exhausted out the open upper end via natural convection; and
a swivel yoke assembly attached to the lower face of the heat sink assembly; the swivel yoke assembly comprising:
an upper bracket,
a lower bracket,
a swivel hub attached to upper bracket and the heat sink assembly,
wherein the upper bracket and the lower bracket are configured to pivot between about +/−30 degrees and about +/−90 degrees about a horizontal axis and the swivel hub is configured to rotate between about +/−45 degrees and about +/−90 degrees about a vertical axis,
a first fastener for fixing a position of the upper bracket and the lower bracket about the horizontal axis, and
a second fastener for fixing a position of the swivel hub about the vertical axis.
